(19) United States
(12) Patent Application Publication
(10) Pub. No.: US 2009/0239516 A1
(43) Pub. Date: Sep. 24, 2009

(54) Method of transferring data, computer programme for switching a mobile communication unit, and primary and secondary data converter

(75) Inventors: Franciscus Wilhelmus Maria Van Eck, Da Loenen (NL); Ramazan-Sami Yilmaz, Haaksbergen (NL); Marinus Van Diggelen, Amsterdam (NL); Philippe Soeters, Den Haag (NL)

Correspondence Address: DAVIDSON BERQUIST JACKSON & GOWDEY LLP, 4300 WILSON BLVD., 7TH FLOOR, ARLINGTON, VA, 22203, US

(73) Assignee: Shared Emotions B.V., Arnhem (NL)

(21) Appl. No.: 11/991,175

(22) PCT Filed: Aug. 23, 2006
(86) PCT No.: PCT/NL2006/000431

§ 371 Date: Dec. 3, 2008

(30) Foreign Application Priority Data
Aug. 30, 2005 (NL) 1029833

(51) Int. Cl. H04M 3/00

(52) U.S. Cl. 455/418; 370/310

(57) ABSTRACT

The present invention provides a method of transferring data from a primary data converter (5) to at least one secondary data converter (5), comprising the steps of: transferring (6) the data from the primary data converter to at least one mobile communication unit (8), which at least one mobile communication unit comprises a user interface for the interaction of the at least one mobile communication unit with a user, and transferring the data from the at least one mobile communication unit to the at least one secondary data converter. The at least one mobile communication unit is switched such that a communication path between the primary and the at least one secondary data converter is created that is transparent to the user. The invention further provides control software for the mobile communication unit as well as a primary and a secondary data converter.

### FIELD OF THE INVENTION

The present invention relates to a method of transferring data from a primary data converter to at least one secondary data converter, comprising the steps of: transferring the data from the primary data converter to at least one mobile communication unit, which at least one mobile communication unit comprises a user interface for the interaction of the at least one mobile communication unit with a user, and transferring the data from the at least one mobile communication unit to the at least one secondary data converter.

The invention further relates to a computer programme for switching a mobile communication unit and to a primary and a secondary data converter for use in the method described above.

The transferring of data in the manner described above is known per se. In the telecommunication industry, for example, appliances are widely used which exchange data with one another via, for example, telephones which are connected to a telecommunication network. An apt example of this is the use of a modem for converting data originating from a personal computer, followed by a transmission of these data over an analog telephone line to a further modem, which then feeds the data into a further computer. The connection between the modem and the telephone may be a wire connection or may equally well be a wireless connection. The same holds for the connection between the telephone used and the telecommunication network; if necessary, for example, mobile telephones may be used so as to have a laptop computer interact with computers on the Internet.

It is a disadvantage of such communication links that the user is at all times aware of the dependence of the connection via the telephone used on the telecommunication network. The user is aware that the exchange of data between the first and the second appliance (such as the user's personal computer and the computer on the Internet) takes place via a link created over the communication network.

When a user desires a connection between, for example, his laptop computer and the Internet, it will probably be irrelevant to the user how this communication link is established. The fact therefore that the user is aware of the use of his mobile telephone, in the example described above, will not constitute a major disadvantage. Matters are different, however, if the content of the communication over the network has a personal emotional value. When a message of a personal nature or a personal notification is to be presented to a recipient by way of a surprise, for example, the surprise effect will be detracted from if the recipient is made aware of the technical details of the communication.

It is accordingly an object of the present invention to provide a method and a means for transferring data which comes close to a direct personal communication and in which the above disadvantages have been eliminated.

To achieve this, the invention in a first of its aspects provides a method of transferring data from a primary data converter to at least one secondary data converter, comprising the steps of: transferring the data from the primary data converter to at least one mobile communication unit, which at least one mobile communication unit comprises a user interface for the interaction of the at least one mobile communication unit with a user, and transferring the data from the at least one mobile communication unit to the at least one secondary data converter, characterized in that the at least one mobile communication unit is switched such that a communication path between the primary and the at least one secondary data converter is created that is transparent to the user.

Switching of the at least one mobile communication unit such that a communication path between the primary and the at least one secondary data converter is created that is transparent to the user will cause the user to perceive this communication as a direct communication between the primary and the secondary data converter. Such a direct communication approximates a personal communication between the users of the primary and secondary data converters in the sense that it seems as if the user of the primary data converter can transmit his feelings directly through the secondary data converter to the receiving user, although the secondary data converter may be at a considerable distance away from the user of the primary data converter. A message sent from the primary data converter to the secondary data converter, with which message the user of the primary data converter intends to surprise the user of the second data converter, will be spontaneously received on the secondary data converter without the user of the secondary data converter being aware of the fact that said at least one communication unit was used for transmitting this message. The personal and spontaneous character of the message is thus kept intact.

It is made possible in this manner to facilitate many different forms of personal communication that exceed the present level of service offered for personal communication within the telecommunication industry. The degree to which the emotional content is affected by the technical means is very low here, indeed reduced to a minimum.

It is made possible in this manner, for example, to provide a primary and a secondary data converter with which an indicative sensation is brought about in the secondary data converter, for example through contacting of the primary data converter (for example through rubbing against or talking to the primary data converter), which sensation may represent a high emotional value for the user of the second data converter. Such an indicative sensation may consist, for example, of the playback of an audio signal, of the secondary data converter becoming warm, or of a lighting up or flickering thereof.

In embodiments of the invention, the input signals received by the primary data converter may be chosen from a group comprising the input of a message (for example by means of speech or a keyboard), contacting of the primary data converter such as by touching, moving, heating, or cooling thereof, the reception of an audio signal such as a speech signal or a whistling signal, and the reception of visual signals such as light signals. Obviously, alternative suitable signals may equally well be used, which signals can be converted by technical means into signals observable to the data converter, such as electrical signals.

In further embodiments, the at least one secondary data converter may be designed for converting the data into at least one indicative sensation, which sensation may be chosen, for example, from a group comprising audio signals such as speech, tones, or music signals, visual signals such as light signals, colour changes, presentations on a display screen, or changes in shape, tactile signals such as vibrations, temperature changes, or changes in shape of the secondary data converter, or other signals such as an odour signal. It is noted here that a change in shape can be regarded as a visual signal but also as a tactile signal. Alternative indicative sensations may obviously be provided by the secondary data converter, for example sensations which are highly suitable for transferring emotions from the user of the primary data converter to the user of the secondary data converter.

In a further embodiment of the invention, the communication between the primary and the secondary data converter can take place not only from the primary to the secondary data converter, but two-way communication is also possible such that data are transferred from the secondary data converter to the primary data converter in a similar manner. This provides the advantage that a two-way communication between the users of the primary and the secondary data converter becomes possible.

The personal character of the communication between the primary and the secondary data converter can be further enhanced in that the primary data converter is designed for communicating with only one, particular secondary data converter, and in that this one secondary data converter is designed for communicating only with this one primary data converter. A combination of a primary and a secondary data converter is unique in this case, and a message received on the secondary data converter will always originate from said primary data converter. Those skilled in the art will appreciate that this strongly emphasizes the emotional value of the communication between the primary and the secondary data converter.

The above can be achieved in that the primary and the secondary data converter are provided with means for storing therein a delivery address for the delivery of data originating from the respective primary or secondary data converter. These means may consist of, for example, a semiconductor memory that has been pre-programmed at the manufacturer's so as to provide the unique combination between primary and secondary data converter, or it is alternatively possible for the user of the primary data converter and the user of the secondary data converter to put in once and for all a delivery address or identification code in the respective primary or secondary data converter for realizing the unique combination.

In a further embodiment of the invention, the at least one mobile communication unit is switched such that in receiving or transmitting the data an activation of the user interface is bypassed so as to provide the transparent communication path. In particular, for example, the at least one mobile communication unit may be designed for generating an initialization signal for activating the user interface upon reception of an incoming data signal. The at least one mobile communication unit may then be switched such that, upon receiving the data from the primary data converter, the step of generating the initialization signal is omitted.

This may be achieved, for example, in that the mobile communication unit recognizes the data as originating from the primary data converter before the initialization signal is generated. As a result, the incoming data from the primary data converter can cause the mobile communication unit to be switched such that the user interface of the mobile communication unit is not activated. The user of the mobile communication unit is not made aware of the fact that the communication has taken place via his/her mobile communication unit then.

It is obviously also possible to hide the communication between the primary and the secondary data converter in a different manner, for example in that the mobile communication unit is switched such that an activation of the user interface is suppressed upon reception or transmission of the data. In this embodiment, the mobile communication unit does generate the initialization signal, but the mobile communication unit is switched in such a manner that no action on the part of the user interface results therefrom.

The initialization signal may be modified, for example, so as to disturb the effect thereof in that it has been made unrecognizable, or so as to make it clear to the mobile communication unit that this initialization signal follows the reception of data from the primary data converter. In the latter case a switching-on of the user interface by the mobile communication unit may be interrupted. It is also possible to cancel the generated initialization signal so that no action is taken in respect thereof.

Another method of suppressing the activation of the user interface may be found, for example, in a temporary switching-off of the user interface upon a reception of data from the primary data converter by the at least one mobile communication unit. If the user interface has been switched off, the occurrence of initialization signals in the mobile communication unit will not lead to the provision of an indication signal via the user interface of the mobile communication unit.

The above preferred embodiments of the invention aim to disable the user interface in such a manner that it is not possible for the mobile communication unit to alert the user in any way whatsoever to the fact that the data were received or transmitted from the primary data converter. The mobile communication unit, though forming an active link in the transmission of the data from the primary data converter to the secondary data converter, thus becomes transparent in the communication path. The users of the primary and the secondary data converter will perceive this in the form of a transparent communication path being established between the primary data converter and the secondary data converter, without the feeling arising that use is being made of a telecommunication network that is in connection with the mobile communication unit or units. The spontaneous and personal character of the communication is maintained thereby.

It should be appreciated in view of the above that the disabling of the user interface is carried out for at least one of the mobile communication units that are used for transmitting the data from the primary to the secondary data converter (or vice versa). In particular, this takes place at the receiving end, i.e. the mobile communication unit that is used as the final station in the communication path, but it preferably holds for all mobile communication units.

In yet another embodiment of the invention, the user interface is activated after reception of the data, but in such a manner that the indication signals provided by the user interface to the user remain unnoticed by the user. An advantage of this embodiment is that the manner of operation of the mobile communication unit need not be substantially modified, but that simple practical procedures can be followed.

Specific examples of the above embodiment consist, for example, in the provision of indication signals from the user interface chosen from a group comprising audio signals of which the audio volume lies below a threshold value such that these signals are inaudible to the user, tactile signals whose intensity lies below a threshold value so as to hide the tactile signals from the user's notice, visual signals with a visual presentation such that the visual signals are not noticeable to the user, for example light signals whose intensity lies below a threshold value or visual presentations on a display screen of the at least one mobile communication unit wherein, for example, the color of the presentation is the same as the background color of the screen. Such indicative signals will remain unnoticed by the user, and accordingly it will appear to the user of the mobile communication unit as if the mobile communication unit is not being addressed.

As was described above, at least one mobile communication unit can be used for providing a communication path. It is noted that, according to a preferred embodiment, at least two mobile communication units are used, wherein the data are transferred from the primary data converter to a first mobile communication unit, and wherein the data are transmitted from the first mobile communication unit to a second mobile communication unit via a telephone network, said second mobile communication unit then passing the data on to the secondary data converter. This renders it possible for users of the primary and the secondary data converter to transmit data from the primary data converter to the secondary data converter while these two are at a major distance from one another. The data are received by the first mobile communication unit and transmitted via the mobile telecommunication network to the second mobile communication unit, which then transfers them to the secondary data converter. This may take place in a conventional manner in the mobile communication network, for example through the establishment of a communication channel based on the principle of GSM (Global System for Mobile communications (GSM)), UMTS (Universal Mobile Telecommunications System (UMTS)), GPRS (General Packet Radio Service (GPRS)), EDGE (Enhanced Data rates for GSM Evolution (EDGE)), CDMA (Code Division Multiple Access (CDMA)) such as W-CDMA (Wideband Code Division Multiple Access (W-CDMA)), or a similar communication protocol. Messaging services may be utilized here, if so desired, for example Short Messaging Service (SMS), Multimedia Messaging Service (MMS) or an Internet Protocol (IP).

Any suitable mobile communication unit may be used for implementing the method according to the invention. Nowadays it is especially mobile telephones such as, for example, “smart phones” or “feature phones” and personal digital assistants (PDAs, for example electronic organizers) that are popular in practice. These mobile communication units are suitable for use in a method according to the present invention.

In an embodiment, the transfer of the data from the primary data converter to the at least one mobile communication unit may comprise the step of establishing a first data communication channel. This data communication channel may be chosen, for example, from a group comprising a Bluetooth channel, Near Field Communication (NFC), Wireless Local Area Network (WLAN), or some other radio link, or possibly an optical link such as that used for the transmission of infrared optical data signals. Said communication protocols are especially suitable for communication over shorter distances (order of magnitude of a few tens or at most a few hundreds of meters).

Use may also be made of a GSM channel, a GPRS channel (General Packet Radio Service (GPRS)), an UMTS channel (Universal Mobile Telecommunications System (UMTS)), or some such communication channel. Although these communication channels are primarily suited to communication over longer distances, the protocol may be used for transmitting the data from the primary data converter to the at least one mobile communication unit. In a particular embodiment, for example, the primary data converter is at the same time a mobile telephone or a personal digital assistant (PDA) by means of which, for example, an SMS message (Short Messaging Service (SMS)), or alternatively an MMS message (Multimedia Messaging Service (MMS)) or a data stream on the basis of an IP protocol (Internet Protocol (IP)), is transmitted along with a certain identification code to the mobile communication unit, which serves as a handling agent for contacting the secondary data converter. It is essential again that the user interface of the mobile communication unit that serves as a handling agent is de-activated, for example in that the triggering of the user interface is suppressed or bypassed.

The same communication protocols that are suitable for transmitting the data from the primary data converter to the at least one mobile communication unit are also suitable for transmitting the data from the at least one mobile communication unit to the secondary data converter. For shorter distances and in preferred embodiments, these are Bluetooth, Near Field Communication (NFC), Wireless Local Area Network (WLAN), or some other radio communication protocol, or data communication by means of infrared radiation. For longer distances, suitable communication protocols such as GSM (Global System for Mobile communications (GSM)), GPRS (General Packet Radio Service (GPRS)), UMTS (Universal Mobile Telecommunications System (UMTS)), Ultra Wideband, or CDMA (Code Division Multiple Access (CDMA)) such as W-CDMA (Wideband Code Division Multiple Access (W-CDMA)) may be used.

According to a second aspect, the invention provides a computer programme for switching a mobile communication unit in accordance with a method as described above with reference to the first aspect of the invention. Said computer programme is designed to recognize the data received by the mobile communication unit from the primary data converter and to switch the mobile communication unit such that a communication path is provided that is transparent to the user of the mobile communication unit, I.e. a communication path between the primary and the at least one secondary data converter.

The computer programme according to the second aspect may be designed for de-activating the user interface in a manner as described with reference to the method according to the first aspect of the invention. The computer programme may further be designed for activating the user interface of the mobile communication unit upon reception of the data from the primary data converter in such a manner that indication signals provided by the user interface to the user remain unnoticed by the user, as was also described with reference to the first aspect of the invention.

Those skilled in the art will understand that a computer programme for switching a mobile communication unit as described above may also have been encoded in an integrated circuit which may have been directly incorporated in a mobile communication unit (for example during the manufacture thereof). Alternatively, such a computer programme may be provided on a data carrier or may be made available in some other manner so that it can be transferred to a mobile communication unit for the purpose of switching the latter.

According to a third aspect, the invention provides a data converter for use as a primary data converter in a method according to the invention, which data converter comprises means for generating data in response to the reception of an input signal, and means for transmitting said data to a mobile communication unit which is to transmit them to a further data converter, wherein said means for generating the data are designed to include in said data identification marks which the mobile communication unit is capable of recognizing.

According to a fourth aspect, the invention provides a data converter designed for use as a secondary data converter in a method according to the first aspect of the invention. This secondary data converter comprises means for receiving data from at least one mobile communication unit and means for converting said data into at least one indicative sensation.

The invention will now be explained in more detail with reference to specific embodiments thereof, which are not meant to be restrictive in any way, and with reference to the accompanying drawings, in which:

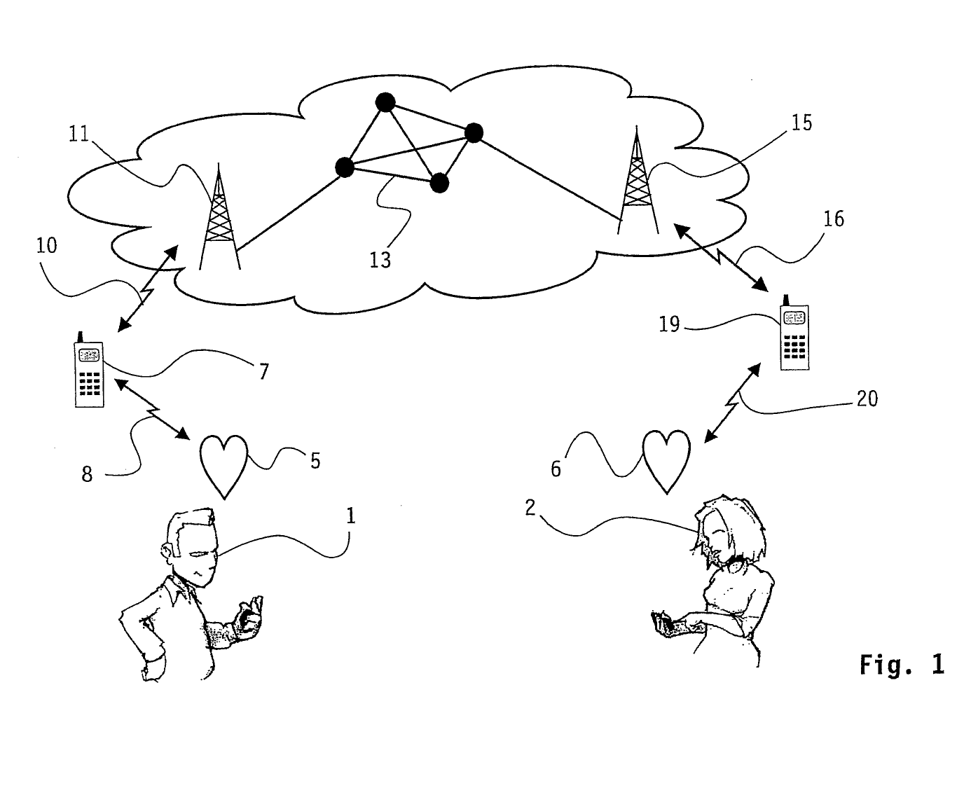

FIG. 1 diagrammatically depicts the method according to the invention;

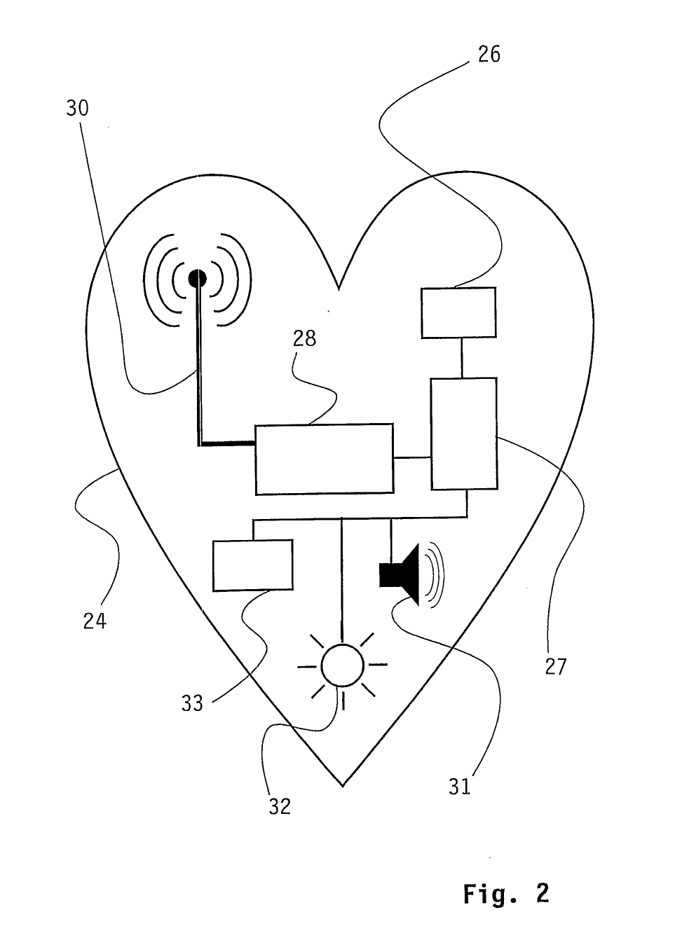

FIG. 2 diagrammatically depicts a data converter according to the invention;

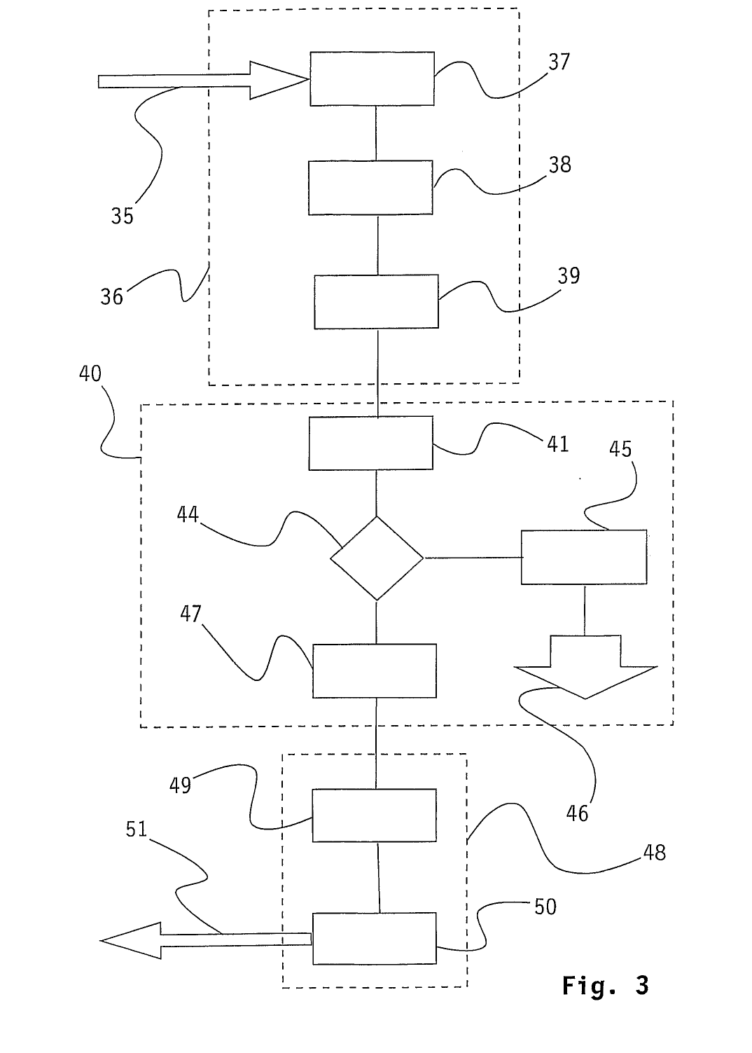

FIG. 3 is a diagram representing the process steps of the invention.

FIG. 1 diagrammatically shows a communication path between a first or primary data converter 5 and a second or secondary data converter 6, which communication path is established by means of a method according to the invention. The primary data converter 5 is in the possession of, for example, a user 1, and the secondary data converter 6 is in the possession of a user 2. The user 1 may want to let the user 2, for example his partner, know that he is thinking of her while he is far away from her. The primary data converter 5 is diagrammatically depicted once more in the hand of the user 1, and the secondary data converter 6 is diagrammatically depicted once more in the hand of the user 2.

By providing input signals to the primary data converter 5 the user 1 will now indicate that he wants to transmit the above emotion to the secondary data converter 6. The primary data converter 5 and the secondary data converter 6 may, for example, be uniquely coupled to one another such that data transmitted by the primary data converter 5 will always have the secondary data converter 6 as their final destination, and vice versa.

The user 1 also possesses a mobile telephone 7, for example carrying it on his person. The user 2 similarly possesses a mobile telephone 19, which at the moment in question is present in the vicinity of the secondary data converter 6. The data generated by the primary data converter upon reception of the input signals (for example an indication that the emotion described above is to be communicated) are transmitted by the primary data converter 5 to the mobile telephone 7, for example in that the primary data converter 5 opens a wireless communication channel of the Bluetooth type.

The data are received by the mobile telephone 7 and recognized as originating from the primary data converter 5. Control software installed on the mobile telephone 7 ensures that the user interface of the mobile telephone 7 is not activated after reception of the data from the primary data converter 5. This may be achieved, for example, in that the activation of the user interface is bypassed, for example in that an initialization signal for activating the user interface (which normally ensures that the user is alerted to the fact that data are received) is not generated, or alternatively, for example, is cancelled. Such an initialization signal may also be modified or interfered with such that it becomes impossible for the mobile telephone 7 to activate the user interface in response to this initialization signal. Another possibility is that a recognition of, for example, the data originating from the primary data converter causes the mobile telephone to switch off the user interface entirely so as to render an activation thereof impossible. Furthermore, it is possible that the user interface is activated normally, but that the control software installed on the mobile telephone ensures that the indication signals provided via the user interface, which are to alert the user, are presented or displayed in such a manner that they are not noticed by the user. Thus, for example, an acoustic signal may have such a low audio volume that it is not heard by the user. It is similarly possible to suppress tactile and visual indication signals or hide them from the user.

After receiving the data, the mobile telephone 7 will transmit them via a wireless communication channel 10 to a base station 11 which is connected to a telecommunication network 13. The data will then be further transmitted from a base station 15 via a wireless connection 16 to the mobile telephone 19. The communication between the mobile telephone 7 and the mobile telephone 19 may be of a conventional type or may possibly take place on the basis of a communication protocol specially defined for this purpose. Those skilled in the art know how to set up the communication path portion between the first mobile telephone 7 and the second mobile telephone 19.

Upon reception of the data on the mobile telephone 19, the control software installed thereon will again ensure that the user interface of the mobile telephone is either not activated or is activated such that the indication signals for alerting the user to the reception of data remain hidden from the user. The user 2 cannot deduce from the state of her telephone 19, therefore, that a message to her is on its way from her lover 1.

The mobile telephone 19 will subsequently pass the data from the primary data converter on to the secondary data converter 6 via a wireless link 20. Again, the wireless link may be, for example, of the Bluetooth type.

The data are received on the secondary data converter 6 and converted therein so as to provide to the user 2 an output signal that is based on the data. This output signal may, for example, consist of an indicative sensation such as, for example, an indicative sensation chosen from a group comprising audio signals such as speech, tones, or music signals, visual signals such as light signals, color changes, presentations on a display screen, or changes in shape, or tactile signals such as vibrations, temperature changes, or changes in shape of the secondary data converter 6, or possibly the generation of an odour signal. The user 2 will experience the received indicative sensation as an emotion transmitted by the user 1. For example, the user 1 may rub over his primary data converter, whereupon the secondary data converter 6 becomes warm, which is interpreted by the user 2 as a received emotion. Alternative modes of transferring emotions are obviously also possible by means of the present method.

Since the communication path between the primary data converter 5 and the secondary data converter 6 is transparent, the spontaneous and personal character of the communication is retained.

FIG. 2 shows a primary data converter 24 that may be used, for example, in a method of transferring data according to the present invention. The primary data converter 24 comprises a tactile sensor 26 capable of sensing, for example, someone's blowing against the primary data converter 24. The tactile sensor 26 is connected to a central processing unit 27, which drives a Bluetooth adapter 28 upon receiving signals from the tactile sensor 26. The Bluetooth adapter 28 is connected to a communication antenna 30. The central processing unit 27 will generate data based on the output signal of the tactile sensor 26, which data comprise, for example, an identification signal identifying the data as originating from the primary data converter 24. These data are then transmitted by the Bluetooth adapter 28 and the communication antenna 30 in a wireless manner over a Bluetooth channel, for example to a mobile communication unit (not shown in FIG. 2).

Inversely, an incoming data signal can be received over a similar Bluetooth channel via the communication antenna 30 and be provided to the central processing unit 27 by the Bluetooth adapter 28. Upon reception of the data from the Bluetooth adapter 28, the central processing unit 27 will activate suitable means (31, 32, 33) into providing an indicative sensation. This may be, for example, a loudspeaker 31 for generating an acoustic signal or a speech signal (for example the voice of the user of another, similar data converter with which the data converter 24 is uniquely coupled). Furthermore, the central processing unit may activate, for example, a light-emitting diode or some other light source 32 so as to provide a light signal. It is further possible, for example, to activate an actuator 33 which ensures that the data converter 24 starts to vibrate, for example, or becomes warm.

FIG. 3 diagrammatically shows the steps in the method according to the present invention. In step 35, a user enters an input signal into, for example, a primary data converter schematically indicated by the broken-line box 36 (note that the process steps 37, 38 and 39 all take place within the data converter 36). The data converter 36 receives the input signals in step 37. In step 38, the data converter will now generate data based on the received input signals and comprising, for example, identification data for identifying the generated data as originating from the data converter 36. In step 39, the data are transmitted by the data converter 36 to, for example, a mobile telephone or PDA diagrammatically indicated by the broken-line box 40. For this purpose, for example, a Bluetooth channel is established for exchanging data between the data converter 36 and the mobile communication unit 40.

In step 41, the transmitted data are received via the Bluetooth channel in the mobile communication unit 40. Decision step 44 serves to decide whether the data originate from the data converter 36, and if this is not the case, for example, an initiation signal will be generated. The handling of received data not coming from the data converter 36 will take place in a conventional manner as indicated by arrow 46 (this will not be explained in any detail, but will be familiar to those skilled in the art).

If it is ascertained in step 44 that the data do originate from the data converter 36, however, the initialization signal for the user interface will not be generated, but instead the data will be passed on to the data converter 48 in a step 47. It is noted that only one mobile communication unit is used in the present case, but it is possible that the data are passed on to a further mobile communication unit in step 47, for example a further mobile telephone in the telecommunication network, so as to be transmitted from this further mobile communication unit on to the data converter 48.

In step 49, the data are received in the data converter 48 and converted into an output signal. In step 50, this output signal is supplied to the receiving user as indicated schematically by arrow 51.

The embodiments shown in the figures are exclusively meant to illustrate the method according to the invention, the primary and the secondary data converter, and the steps carried out by the control programme for the mobile communication unit. The scope of the invention described herein is limited by the ensuing claims only. It will accordingly be clear that the embodiments shown and described do not limit the invention in any way.

1. A method of transferring data from a primary data converter to at least one secondary data converter, comprising the steps of:
transferring the data from the primary data converter to at least one mobile communication unit, which at least one mobile communication unit comprises a user interface for the interaction of the at least one mobile communication unit with a user, and
transferring the data from the at least one mobile communication unit to the at least one secondary data converter,
characterized in that the at least one mobile communication unit is switched such that a communication path which is transparent to the user between the primary and the at least one secondary data converter, is created for transferring said data.

2. A method according to claim 1, wherein the at least one mobile communication unit is switched such that in receiving or transferring the data an activation of the user interface is bypassed so as to provide the transparent communication path.

3. A method according to claim 2, wherein the at least one mobile communication unit is designed for generating an initialization signal for activating the user interface upon reception of an incoming data signal, and wherein the at least one mobile communication unit, upon receiving the data from the primary data converter, is switched such that the step of generating the initialization signal is omitted.

4. A method according to claim 1, wherein the mobile communication unit is switched such that an activation of the user interface is suppressed upon reception or transmission of the data so as to provide the transparent communication path.

5. A method according to claim 4, wherein the activation of the user interface is suppressed through switching-off of the user interface upon a reception of the data by the at least one mobile communication unit.

6. A method according to claim 4, wherein the at least one mobile communication unit is designed for generating an initialization signal for activating the user interface upon reception of an incoming data signal, and wherein the activation of the user interface is suppressed by means of a change in the initialization signal for the user interface.

7. A method according to claim 4, wherein the at least one mobile communication unit is designed for generating an initialization signal for activating the user interface upon reception of an incoming data signal, and wherein the activation of the user interface is suppressed through a cancellation of the initialization signal for the user interface.

8. A method according to claim 1, wherein the user interface is activated such that, after reception of the data, the indication signals provided by the user interface to the user remain unnoticed by the user, for providing the transparent communication path.

9. A method according to claim 8, wherein the indication signals provided by the user interface are chosen from a group comprising audio signals of which the audio volume lies below a threshold value such that these signals are inaudible to the user, tactile signals of which the intensity lies below a threshold value so as to hide the tactile signals from the user's notice, visual signals with a visual presentation such that the visual signals are not noticeable to the user, such as light signals of which the intensity lies below a threshold value, or visual presentations on a display screen of the at least one mobile communication unit wherein the color of the presentation is the same as the background color of the display screen.

10. A method according to claim 1, wherein the step of transferring the data from the primary data converter to at least one mobile communication unit comprises a step of transferring the data to at least one first mobile communication unit among the at least one mobile communication unit.

11. A method according to claim 10, wherein the step of transferring the data from the at least one first mobile communication unit to the at least one secondary data converter comprises the steps of transferring the data from the first mobile communication unit to a second mobile communication unit among the at least one mobile communication unit, and of transferring the data from the second mobile communication unit to the at least one secondary data converter.

12. A method according to claim 1, wherein the at least one mobile communication unit is chosen from a group comprising mobile telephones and personal digital assistants (PDAs).

13. A method according to claim 1, wherein the step of transferring the data from the primary data converter to the at least one mobile communication unit comprises a step of establishing a first data communication channel.

14. A method according to claim 13, wherein the first communication channel is chosen from a group comprising a Bluetooth channel, a channel of the Near Field Communication (NFC) type, a channel of the Wireless Local Area Network (WLAN) type, a channel of the Global System for Mobile communications (GSM) type, a channel of the General Packet Radio Service (GPRS) type, a channel of the Universal Mobile Telecommunications System (UMTS) type, Ultra Wideband, Code Division Multiple Access (CDMA), an optical link such as that for transferring infrared optical data signals, or some other type of radio communication channel.

15. A method according to claim 1, wherein the step of transferring the data from the at least one mobile communication unit to the at least one secondary data converter comprises a step of establishing a second communication channel.

16. A method according to claim 13, wherein the second communication channel is chosen from a group comprising a Bluetooth channel, a channel of the Near Field Communication (NFC) type, a channel of the Wireless Local Area Network (WLAN) type, a channel of the Global System for Mobile communications (GSM) type, a channel of the General Packet Radio Service (GPRS) type, a channel of the Universal Mobile Telecommunications System (UMTS) type, Ultra Wideband, Code Division Multiple Access (CDMA), an optical link such as that for transferring infrared optical data signals, or some other type of radio communication channel.

17. A method according to claim 1, wherein the data are converted into at least one indicative sensation in the at least one secondary data converter.

18. A method according to claim 17, wherein the at least one indicative sensation is chosen from a group comprising audio signals such as speech, tones, or music signals, visual signals such as light signals, color changes, presentations on a display screen, or changes in shape, or tactile signals such as vibrations, temperature changes, or changes in shape, or other perceivable signals such as an odour signal.

19. A method according to claim 17, wherein the indicative sensation is pre-programmed by the user of the secondary data converter.

20. A method according to claim 1, further comprising the step of receiving by the primary data converter of an input signal for initiating the step of transmitting the data to the at least one mobile communication unit.

21. A method according to claim 20, wherein the receiving of the input signal is chosen from a group comprising the input of a message, the contacting of the primary data converter such as by touching, moving, heating or cooling of the primary data converter, the receiving of an audio signal such as the receiving of a whistled or spoken signal, and the receiving of a visual signal such as a light signal.

22. A method according to claim 1, further comprising a step of transmitting response data from the at least one secondary data converter to the primary data converter via the transparent communication path.

23. A method according to claim 1, further comprising a step of taking up by the primary data converter of identification data of a secondary data converter with which the primary data converter is uniquely coupled.

24. A computer programme for switching a mobile communication unit, said computer programme recognizes data received by the mobile communication unit and transmitted by the primary data converter, and in response thereto establishes a communication path in the mobile communication unit with that communication path being transparent to the user between the primary and the at least one secondary data converter as data is transferred.

25. A computer programme according to claim 24, wherein within the mobile communication unit activation of a user interface of the mobile communication unit is bypassed upon a reception or transmission of said data.

26. A computer programme according to claim 24, wherein within the mobile communication unit activation of a user interface of the mobile communication unit is suppressed upon a reception or transmission of said data.

27. A computer programme according to claim 24, wherein within a user interface of the mobile communication unit upon activation indication signals provided by the user interface to the user remain unnoticed by the user in the case of reception of data from the primary data converter.

28. A data converter designed for use as a primary data converter, comprising means for generating data in response to the reception of an input signal and means for transferring said data to a mobile communication unit which is to transfer the data to a further data converter, wherein said means for generating the data are designed to include in said data identification marks which the mobile communication unit is capable of recognizing.

29. A data converter according to claim 28, further comprising means for receiving an input signal chosen from a group comprising messages, touching of the data converter, motion of the data converter, temperature changes of the data converter, visual signals, and acoustic signals.

30. A data converter according to claim 28, wherein said data converter acts as a secondary data converter and further comprising means for converting the data into at least one indicative sensation.

31. A data converter according to claim 30, wherein said indicative sensation is chosen from a group comprising acoustic signals such as speech, tones, or music signals, visual signals such as light signals, color changes, presentations on a display screen, or changes in shape, or tactile signals such as vibrations, temperature changes, or changes in shape, or other signals such as an odour signal.

32. A data converter for use as a secondary data converter according to claim 30, further comprising means for receiving the data from at least one mobile communication unit and means for converting said data into at least one indicative sensation.

33. A data converter according to claim 32, wherein said indicative sensation is chosen from a group comprising acoustic signals such as speech, tones, or music signals, visual signals such as light signals, colour changes, presentations on a display screen, or changes in shape, or tactile signals such as vibrations, temperature changes, or changes in shape, or other signals such as odour signals.
